(19) United States
(12) Patent Application Publication
(10) Pub. No.: US 2010/0025645 A1
(43) Pub. Date: Feb. 4, 2010

(54) Ratchet Device with Self-Storing Strap

(76) Inventors: John Victor Carlson, Brandon, FL (US); Steven Patrick Vantoorenburg, Tampa, FL (US)

Correspondence Address: Steven P. Vantoorenburg, 515 Carriage Hills Drive, Tampa, FL, 33617, US

(21) Appl. No.: 12/510,027

(22) Filed: Jul. 27, 2009

Related U.S. Application Data
(60) Provisional application No. 61/137,794, filed on Aug. 4, 2008.

(51) Int. Cl. B25B 25/00

(52) U.S. Cl. 254/218

(57) ABSTRACT

A ratchet device is provided that includes a base frame with the drive mechanisms located on the outside of the base frame so that a removable strap may be stored on a rotatable shaft about an axis relative to the base frame. The aforementioned outer drive mechanisms include a rotatable shaft knob, a latching bar, a drive bar, and a release cam.

### CROSS-REFERENCE TO RELATED APPLICATIONS

This application claims the benefit of U.S. Provisional Application No. 61/137,794 filed on Aug. 4, 2008, the entire disclosure of which is hereby incorporated herein by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of Invention

The present invention relates generally to a ratchet and strap storage device utilized to secure an object.

2. Description of the Prior Art

The typical prior art conventional ratchet device, which is modified to make the present invention, includes a rotatable shaft provided at one end of a base frame. The rotatable shaft is journaled in one end of the base frame, thus providing for rotatable attachment of a tension lever to the base frame. A short, fixed strap is firmly secured to a bolt or pin in the other end of the base frame, and has at its free end, a hook or other device for attachment to an object.

A second, removable strap has a hook or other device at one of its ends for attachment to an object. The other end of the removable strap is inserted through a slot in the rotatable shaft. A ratchet arrangement permits tightening of the strap by back and forth movement of the tension lever with respect to the base frame. Because the base frame is held firmly in place by the first, fixed strap, the second, removable strap tightens around the rotatable shaft. The ratchet device is conventional and, therefore, will not be described in any great detail except with regard to the modification of the drive mechanism to provide removable strap storage embodied in the present invention.

A common problem when using the above mentioned conventional ratchet device with straps concerns the handling of the removable strap when not used in securing an object. The conventional ratchet device does not provide means for storage of the removable strap leading to difficulty in handling of the device when not in use. This difficulty is compounded when multiple devices are used, which is typically the case. The difficulty in handling of the device can lead to improper storage and tangling of the straps. Improper storage may result in premature degradation of the straps, compromising their integrity.

Many attempts to solve these problems are known in the prior art. US Patent Publications No. U.S. Pat. No. 5,316,266 to Chou, U.S. Pat. No. 5,611,520 to Soderstrom, U.S. Pat. No. 6,102,371 to Wyers, U.S. Pat. No. 6,609,275 B1 to Lin, U.S. Pat. No. 7,017,847 B2 to Treat, U.S. Pat. No. 7,100,901 B2 to Gleinser, U.S. Pat. No. 7,100,902 B1 to Lu, and U.S. Pat. No. 7,296,326 B2 to Madachy, all show a strap storage system including a strap fastener, and a winding device for winding the strap. The winding device includes an additional housing or magazine which is attached to a base frame portion of the typical prior art conventional ratchet device. A reel is put in the housing or magazine for winding the strap.

U.S. Pat. No. 4,842,458 to Carpenter, and U.S. Pat. No. 6,200,079 B1 to Little, show a strap storage system including a strap fastener, and a winding device for winding the strap. The winding device includes an additional housing which is separate from the base frame portion of the typical prior art ratchet device. A reel is put in the separate housing for winding of the strap.

U.S. Pat. No. 5,282,706 to Anthony, U.S. Pat. No. 6,007,053 to Huang, and US Pat. Publication No. US 2007/0189873 to Breeden, show a ratchet device with an auto-pulling device connected to a rotatable shaft. The auto-pulling device includes a reversing device. The reversing device is rotatably received around the rotatable shaft for winding of the strap.

U.S. Pat. Publication No. 2004/0046077 A1 to Kramer, shows a conventional ratchet device with a guide attached to the base frame and a guide attached to the tension lever. The removable strap is hand wound around the ratchet device through the guides for storage.

All of the above prior art ratchet devices perform generally satisfactorily, but share the problem of relatively high costs, cumbersome attachments, and difficulty of manufacture. The auto-pulling ratchet devices share the additional problem of limited strap length due to the space requirements of the auto-pulling mechanisms.

### BRIEF SUMMARY OF THE INVENTION

The aim of the present invention is to provide a ratchet device and strap collector which is more cost effective compared with prior art devices, is less bulky, and is easier to manufacture. This is accomplished by moving the drive mechanisms to the outside of the base frame, rather than on the inside, as in prior art. The aforementioned outer drive mechanisms include a rotatable shaft knob, a latching bar, a drive bar, and a release cam. The advantages of this improved design will become apparent by a careful reading of the detailed description, with appropriate reference to the accompanying drawings, wherein like numerals designate like parts in the several views.

### BRIEF DESCRIPTION OF THE SEVERAL VIEWS OF THE DRAWING

The invention is to be described in more detail below using exemplary embodiments.

FIG. 1 is a perspective view of a construction embodying the present invention.

FIG. 2 is an perspective view of the construction of FIG. 1 in its open position without a removable strap and without a fixed strap.

FIG. 3 is a side elevational view of the construction of FIG. 1 in its open position without removable strap and without fixed strap.

FIG. 4 is a top plan view of the construction of FIG. 1 in its open position without removable strap and without fixed strap.

### DETAILED DESCRIPTION OF THE INVENTION

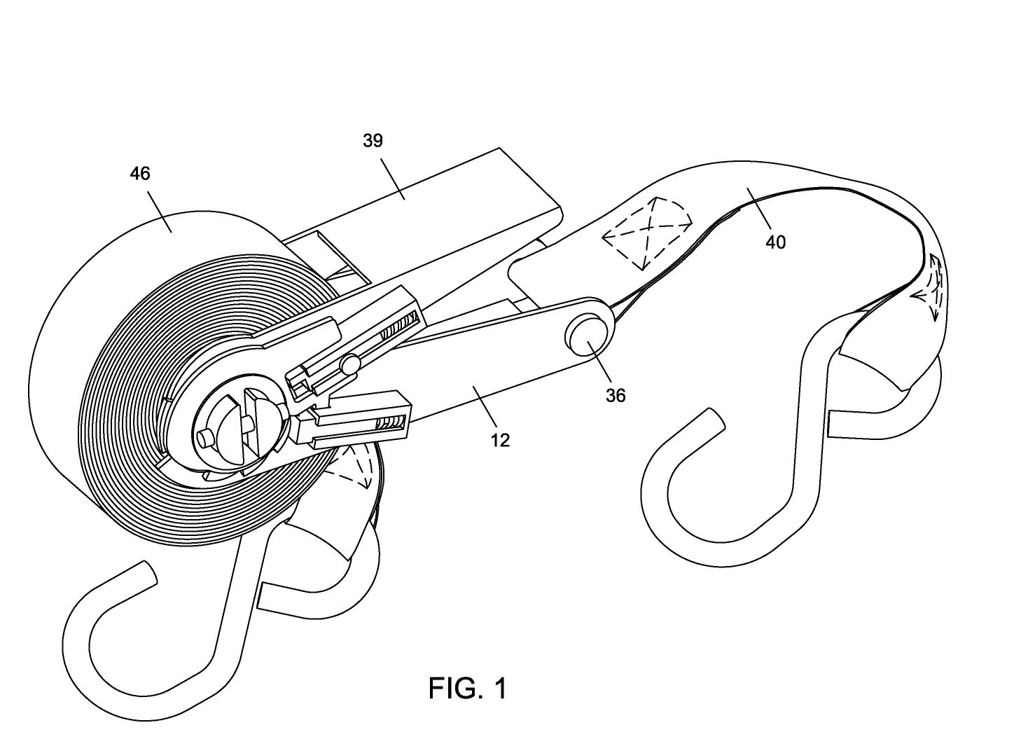

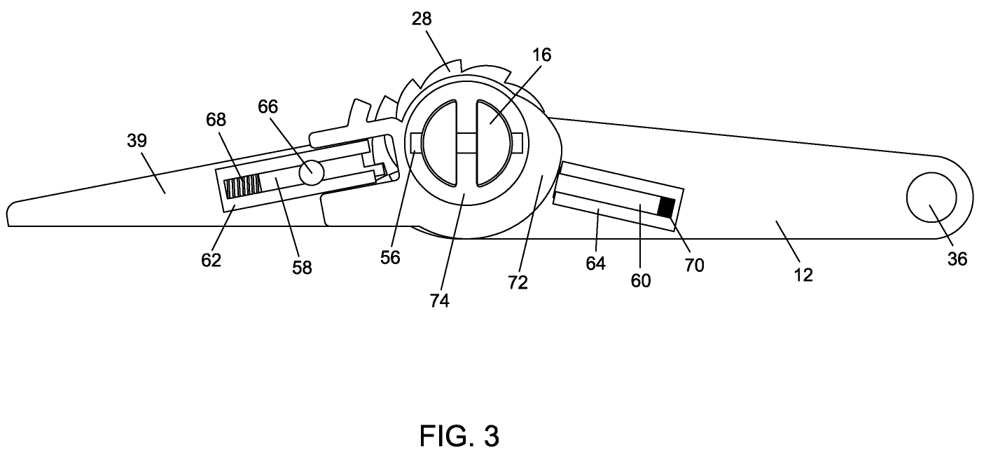

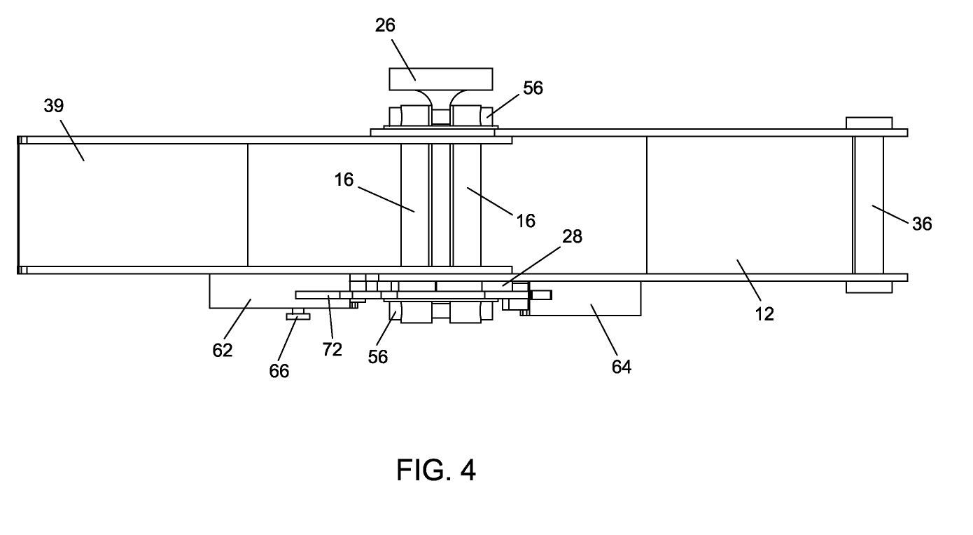

The present invention relates to a new design of a ratchet device to solve the problems of strap storage. Referring now to FIGS. 1-4, the present invention relates to an improved ratchet device with strap storage capability. An improved ratchet device for tightening and collecting a strap includes a base frame 12 and a tension lever 39 (FIG. 1). Base frame 12 extends in a longitudinal direction. As with prior art, there is provided a rotatable shaft 16 journaled for rotation in one end of base frame 12. At the other, or second, end of base frame 12 is provided a strap pin 36, to which a fixed strap 40 is attached. A hook or other fastening device is attached to the other end of fixed strap 40.

As in the prior art devices, reciprocal rotation of tension lever 39 will cause co-rotation of rotatable shaft 16. Journals for rotatable shaft 16, are provided by opposed apertures provided in a first pair of spaced apart sidewalls provided in base frame 12, and a second pair of spaced apart sidewalls in tension lever 39. On one end, a washer 74 and a rotatable shaft pin 56 prevent rotatable shaft 16 from sliding out of base frame 12. Rotatable shaft 16 is provided therein with a slot to accept the free end of a removable strap 46 as hereinafter described. A rotatable shaft knob 26 is attached to rotatable shaft 16. Rotatable shaft knob 26 can be manually rotated to wind removable strap 46 around rotatable shaft 16.

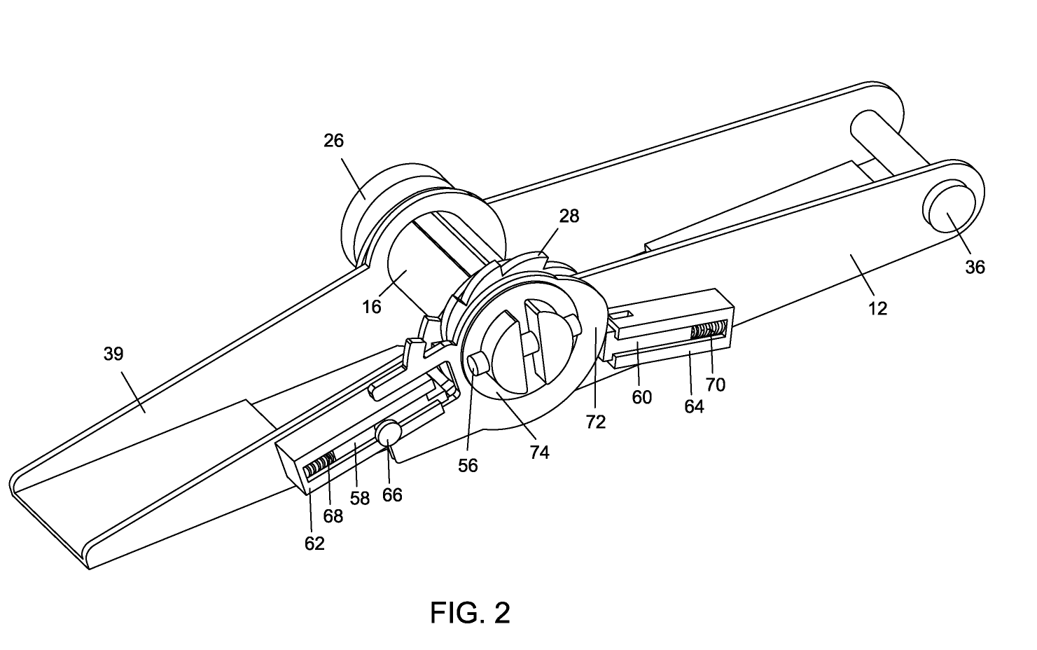

Reciprocal rotation of tension lever 39 will cause co-rotational rotation of rotatable shaft 16 by virtue of a ratchet wheel 28 which is mounted on rotatable shaft 16 between the sidewall and base frame 12 and tension lever 39. A drive bar 58 aides in the rotation of rotatable shaft 16 by operating on ratchet wheel 28. Drive bar 58 is spring loaded by a drive bar spring 68 and slides within a drive bar housing 62 (FIG. 2).

A latching bar 60 engages ratchet wheel 28 and limits rotatable shaft 16 to unidirectional rotation during operation to maintain tension on removable strap 46. Latching bar 60 is spring loaded by a latching bar spring 70 and slides within a latching bar housing 64 (FIG. 2). To disengage latching bar 60, drive bar 58 must first be released utilizing a drive bar knob 66. Tension lever 39 is rotated to cause co-rotation of a release cam 72. At the open position, release cam 72 disengages latching bar 60 from ratchet wheel 28 to allow bi-directional rotation.

For storage of removable strap 46 the free or non-active end is first passed through a slot in rotatable shaft 16. Rotatable shaft 16 is then rotated, with the aid of rotatable shaft knob 26, to wind up the free end of removable strap 46. Tension lever 39 is utilized to create wound tension in removable strap 46 to restrain removable strap 46 in stored condition (FIG. 1).

In use, removable strap 46 is completely unrolled and removed from rotatable shaft 16. The hook, or other fastening device, is attached to the object (not shown) at the appropriate location. The free end of removable strap 46 is placed through the slot in rotatable shaft 16, and tension lever 39 is reciprocally rotated, causing co-rotational movement of rotatable shaft 16. Since removable strap 46 is inserted in the slot of rotatable shaft 16, and base frame 12 is restrained by fixed strap 40 and its hook, or other fastening device, the ratchet device is tightened down on the object.

Thus, by carefully considering the problems in the prior art ratchet devices, we have provided a novel ratchet device with a self-storing strap which is more compact, less cumbersome, simpler in construction, easier to manufacturer and less costly than prior art devices.

1. A ratchet device for tightening and collecting a strap, comprising:
a) a base frame pivotally connected to a tension lever by a rotatable shaft,
b) a rotatable shaft knob mounted to said rotatable shaft for manual rotation of said rotatable shaft,
c) a drive bar housing mounted to the external surface of said tension lever encasing a drive bar,
d) a latching bar housing mounted to the external surface of said base frame encasing a latching bar,
e) a release cam located external to the surface of said base frame,
f) a ratchet wheel mounted concentrically to said rotatable shaft.

2. The ratchet device of claim 1, said drive bar and said latching bar providing a means for selectively allowing said rotatable shaft to rotate only in a single direction during tensioning operation.

3. The ratchet device of claim 1, whereby said ratchet device will controllably store said removable strap by spindling around said rotatable shaft.
